(19) United States
(12) Patent Application Publication
(10) Pub. No.: US 2005/0170040 A1
(43) Pub. Date: Aug. 4, 2005

(54) Composition of matter comprising edible surface and substrate, edible ink, non-toxic adhesive, and processed aromatic oil for attracting domesticated animals and process for making same

(76) Inventor: Reynolds Ellsworth Moulton, New York, NY (US)

Correspondence Address: Reynolds E. Moulton III;c/o Dogmatic Products, 35 Yark Street #1000, Brooklyn, NY, 11201, US

(21) Appl. No.: 10/770,246

(22) Filed: Feb. 2, 2004

(51) Int. Cl. A23L 1/00

(52) U.S. Cl. 426/1

(57) ABSTRACT

A composition of matter with edible substrate (paper), edible ink, edible sticker, utilizing Catnip oil or particles, and utilizing edible ink for color both of which are printed onto the sticker surface. The edible sticker utilizes non-toxic, edible, dyes to create color used for colored images. These adhesive stickers attract felines through the use of a chemical additive, the aromatic oil (or essence) of the herbaceous plant catnip which is absorbed into the sticker paper along with the dye to create images that can then be peeled off and placed on objects for the amusement of the feline.

### CROSS REFERENCE TO RELATED APPLICATIONS

U.S. PATENT DOCUMENTS

| | | | |
|---|---|---|---|
| 4,435,840 | July 1995 | Hilborn | 106/20 R |
| 4,543,370 | September 1985 | Porter, et al | 523/100 |
| 4,915,971 | April 1990 | Fennema et al | 426/578 |
| 5,089,307 | February 1992 | Ninomiya et al | 428/35.2 |
| 5,453,122 | September 1995 | Lyon | 160/20 R |
| 5,567,436 | October 1996 | Udelle | 524/17 |
| 5,797,353 | August 1998 | Leopold | 119/710 |
| 6,616,958 B1 | September 2003 | Stewart | 426/383 |

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of cat toys and amusements that utilize catnip as an attractor and more specifically to a composition of matter comprising edible substrate (e.g. paper), ingestible ink, and processed aromatic catnip oil (or catnip frahments) for attracting animals (such as a catnip, scientific name of active ingredient Nepeta cataria L.) and process for making same.
Adhesive stickers have been used for many purposes, from decoration to use in notation. In some industry edible stickers have been used, primarily in the food industry to mark such foodstuffs as fruits and vegetables, and to insure that if the labeling is eaten mistakenly that it does not harm to the person that ingests it. Most often, the matter used is organic, such as a rice based paper, and it can be easily digested. In addition, non-toxic dyes are used for coloration/pigmentation.
Additionally, the invention utilized aromatic oils primarily from the herbaceous plant species Catnip (Nepeta Cataria L.). Catnip is a species belonging to the mint family (Labitae). Catnip is more commonly known as catment, catmint, and cats-toys. Catnip produces a euphoric effect in cats when it is ingested, and the aroma attracts cats. Adhesive stickers are commonplace, and have been used for several decades. While not specific to an ornamental sticker, U.S. Pat. No. 5,089,307, by Ninomiya et al. Feb. 18, 1992, uses an edible film composed of a film layer containing a water-soluble polysaccharide as the principal component, or comprising at least a) a film layer as described above b) a subfilm layer as described above and c) a subfilm layer containing an alkali metal salt of casein, soybean protein and gelatin, as the principal component. The similarity is that an edible base is used to insure against problems with ingestion; in the case of U.S. Pat. No. 5,089,307 by Ninomiya et al. Feb. 18, 1992, to seal or package foods.
Edible inks have been used as well, in cases in conjunction with edible stickers on food stuff to insure safe ingestion. In U.S. Pat. No. 5,453,122, by Lyon, Sep. 26, 1995, edible ink containing acetone and at least one other solvent selected from water, an alkanol and/or an alkyl ester of an alkyl carboxylic acid and to a method for printing images with the ink compositions using an ink jet printer is referenced. Edible inks have been used in other instances, outside the realm of foodstuff, such as water-soluble edible ink for pigmentation in decorative body paint for children, and in U.S. Pat. No. 5,435, 840, by Hilborn, Jul. 25, 1995, a method is described for using edible ink for branding pharmaceuticals.
A number of products and inventions utilize catnip (in the leaf, oil, or essence form) as a chief component for attracting and exciting cats. In U.S. Pat. No. 5,567,436, by Udelle, Oct. 22, 1996, the extraction process for deriving the oil from the plant catnip is described. In U.S. Pat. No. 5,797,353, by Leopold, Aug. 25, 1998, a plastic object for attracting a cat formed by impregnating particulate matter, such as particles of catnip into the object during the molding process, illustrates the use of utilizing catnip in one form within a substance to attract cats.
While there are adhesive stickers, and edible stickers, and catnip oils, and edible inks used, none have been used in a novel way to create stickers that can be used to turn any object into a safe attractive play item for cats. Catnip oil can be used as an attractor, to put into a toy, or onto an object, but the method is imprecise and can be messy. This invention allows a cat owner to use a whimsical image, in safe edible substrate (such as rice paper), non-toxic adhesive, and edible ink, that has absorbed catnip oil to safely decorate any object to allow his or her cat to play with that object. It is a way to easily use any toy to make it more attractive for the cat, with minimal mess, and in a manner that is easy to clean.
While other objects utilize catnip either in its leaf form or in another form, such as oil, this invention can be easily manipulated, placed on an object, and disposed of after the aroma of the catnip has diminished, to be easily replaced with another object of its kind.

### BRIEF SUMMARY OF THE INVENTION

The primary object of the invention is to create an adhesive, edible sticker that can turn any object into a cat toy.

Another object of the invention is to create whimsical images that will visually stimulate a cat.

Another object of the invention is to create an object that can be easily removed or placed on ordinary household objects.

Another object of the invention is to create an object of play for a cat that is safe if it is ingested by the cat as a result of using edible paper, ink, and safe doses of catnip.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a composition of matter comprising edible substrate (paper), edible adhesive, utilizing catnip (either catnip oil or catnip particles), and utilizing edible ink for color.

In accordance with a preferred embodiment of the invention, there is disclosed a process for a composition of matter comprising edible substrate and surface e.g. paper, edibleink, edible adhesive, utilizing Catnip oil (or catnip particles), and utilizing edible ink for color.

The invention can be made by using current printing technology where organic inks are pre-mixed with variable levels of Catnip oil or particles to then print directly onto pre-scored sheets of edible stickers that have a non-toxic adhesive to attach them to a layer (such as paper).

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrated a perspective view of the edible sticker sheet (the surface covered with edible ink mixed with Catnip oil or particles) with example peel off stickers in whimsical shapes.

FIG. 2 shows a front view of the edible sticker sheet with an example of the peeling upwards of one of the stickers 12 from adhesive covered surface 16.

FIG. 3 shows a side view of the edible sticker sheet, illustrating the base layer 10, the adhesive layer 14, and the top layer with stickers (which is suffused with edible ink for coloration and attractive aroma bearing oil or particles, such as from Catnip).

FIG. 4 shows the back of the edible sticker sheet of FIG. 1

### DETAILED DESCRIPTION OF THE PREFERRED EMBODIMENT

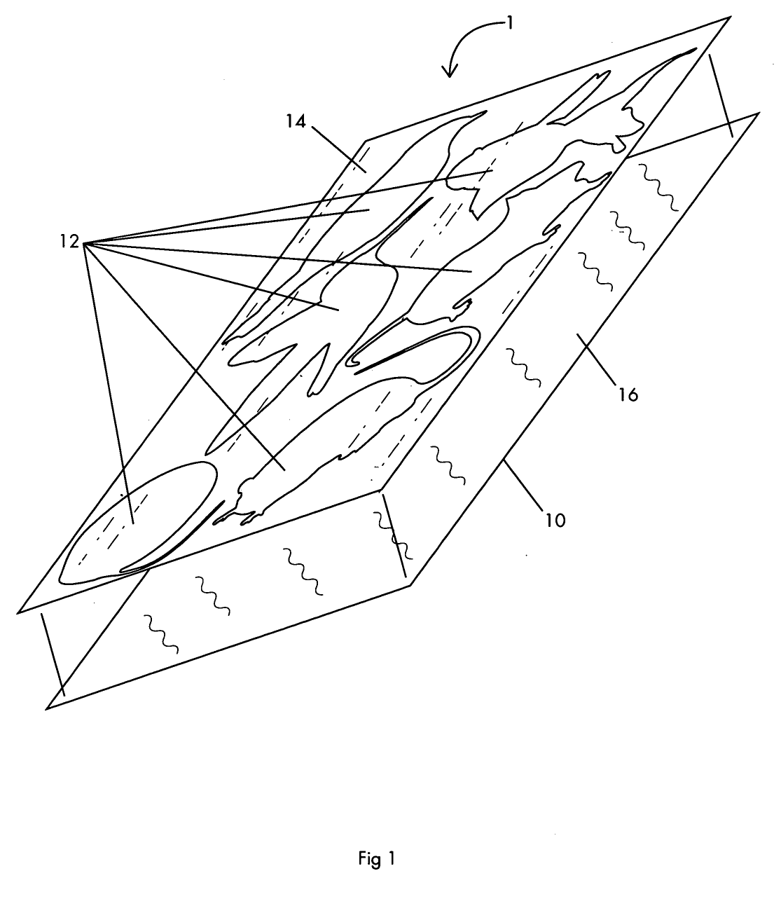

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.
The combination sheet of stickers 1 and peel off stickers 12 which forms the present invention is described in detail while referring concurrently to FIG. 14 of the drawings. The sticker sheet 1 is a composition of a non-toxic, edible paper, made preferably from organic materials such as rice. As is best shown on FIG. 1, in an angled perspective view, the printed indicia 12 can be peeled off. Whimsical shapes such as balls of string, birds, fish or other objects which are intended to be attractive to animals, more specifically in this case for domesticated animals such as cats and dogs, are used, optionally employing multiple colors to add more lifelike details to the animal shapes or representations 12. The inks employed would be non-toxic, for example inks derived from natural pigment from fruits, vegetable or herbs that are currently used on indicia on food items (as to be safe for possible ingestion). In addition, a catnip—in the form of pulverized catnip (Nepeta cataria L) or in the form of catnip oil would be added to the ink used in coloring stickers 12 to make the edible sticker matter more attractive to animals (such as felines).

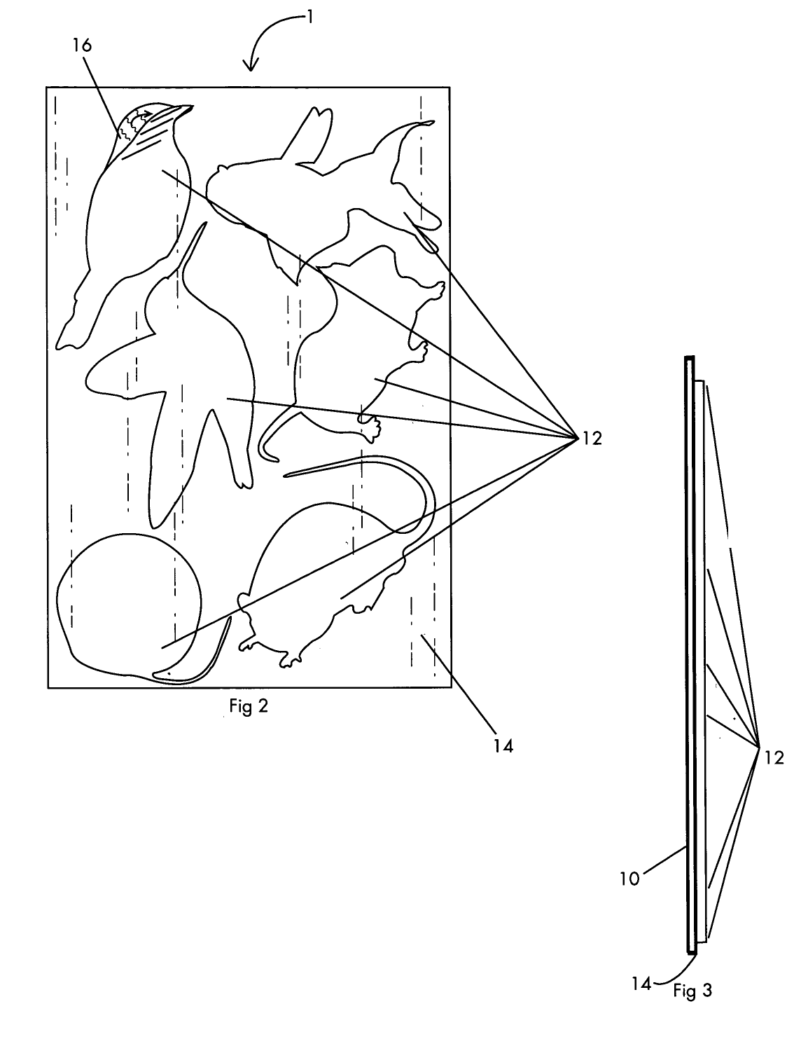

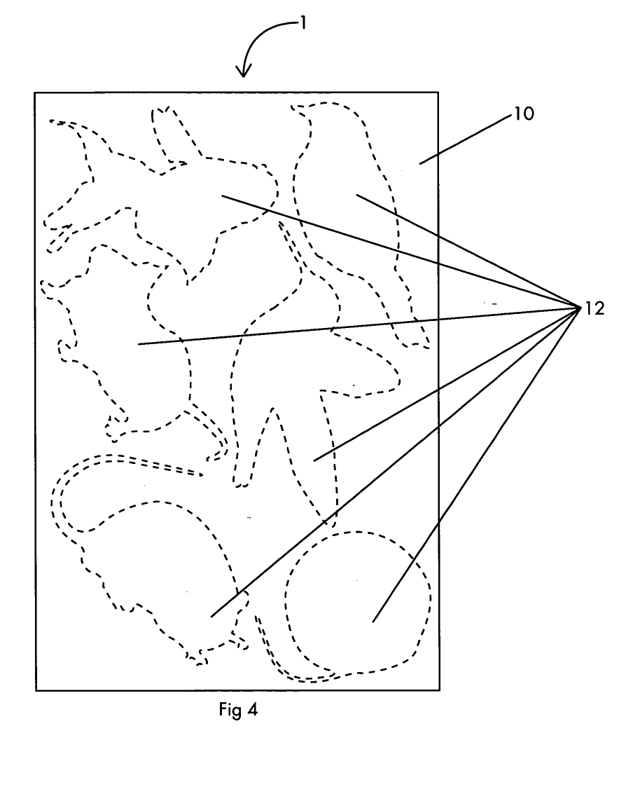

FIG. 2, a front view of the adhesive sticker sheet, better shows the sample objects mentioned in the previous paragraph: optionally images such as mice, birds, and string are shown. Stickers 12 can be peeled off, leaving behind the top of an adhesive covered layer 16, this base layer is typically a wax paper (and is not meant for ingestion but only as a layer to rest the adhesive covered stickers 12 upon). The adhesive substrate used at the base of stickers 12 would also be non-toxic and safe to ingest for animals.
FIG. 3 shows a side view of the sticker sheet, with the top later including peel off stickers 12 of edible paper with edible ink and catnip oil (or catnip particles) above the an adhesive 14 and a base later 10.
FIG. 4 shows the back of the edible sticker sheet of FIG. 1, from the vantage point of the base layer 16, which would most likely be wax paper or such.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A composition of matter comprising edible substrate (paper) and edible adhesive, edible ink,
Edible sticker;
Utilizing Catnip oil or particles; and
Utilizing edible ink for color.

2. A process for a composition of matter comprising edible substrate (paper), organic (edible) ink, edible sticker;
Utilizing Catnip oil or catnip particles; and
Utilizing edible ink for color.
